(19) United States
(12) Patent Application Publication
(10) Pub. No.: US 2014/0252036 A1
(43) Pub. Date: Sep. 11, 2014

(54) FLASHLIGHT AND INTEGRATED PEPPER SPRAY

(71) Applicant: Jay A. Ballard, Mapleton, UT (US)

(72) Inventor: Jay A. Ballard, Mapleton, UT (US)

(21) Appl. No.: 14/201,622

(22) Filed: Mar. 7, 2014

Related U.S. Application Data
(60) Provisional application No. 61/851,335, filed on Mar. 7, 2013.

(51) Int. Cl. F21V 33/00; F41H 9/10

(52) U.S. Cl. CPC F21V 33/0076; F41H 9/10
USPC 222/113; 222/402.11; 362/96; 222/175; 222/192

(57) ABSTRACT

Described herein is a flashlight apparatus includes a light emitting module at a distal end, a pepper spray module at a proximal end, and a plurality of interchangeable modules positioned between the light emitting module and the pepper spray module. The pepper spray module includes an actuator, a nozzle, and a pepper spray compartment capable of housing a pepper spray source. The actuator includes a pepper spray switch and a pepper spray channel. Actuation of the pepper spray switch releases pepper spray fluid from the pepper spray source, and through the pepper spray channel and nozzle. The interchangeable modules include a power supply with a power source and a power switch module for selectively supplying power from the power source to the light emitting module when the power source is housed by the power compartment.

### CROSS-REFERENCES TO RELATED APPLICATIONS

This application claims the benefit of U.S. Provisional Patent Application No. 61/851,335, filed Mar. 7, 2013, which is incorporated herein by reference.

### FIELD

The subject matter of the present disclosure relates generally to electronic devices with modular interchangeable components and more particularly to flashlight systems and pepper spray systems.

### BACKGROUND

Flashlights are commonly used by police officers, military personnel, and other individuals in situations where defensive combat is likely to occur. For example, police officers often use a flashlight to visually inspect a location and/or to visually examine a suspect. In such situations, an assailant may quickly appear or a suspect may become aggressive, thus requiring the police officer to quickly employ a defensive combat maneuver to prevent the assailants attack and/or to temporarily incapacitate the assailant.

Pepper spray and other lachrymatory agents are commonly utilized by people (not just police officers) to temporarily incapacitate an assailant. Pepper spray can be dispensed from a container into an assailants face, specifically targeting the eyes of the assailant. The pepper spray has an inflammatory effect on the eyes, causing the eyelids to close and thus rendering the assailant temporarily blind.

In certain situations, a person may benefit from having both a flashlight and pepper spray equipped and in hand. For example, a police officer inspecting a location or visually examining a suspect would benefit from having a flashlight in hand while maintaining a pepper spray canister in an easily accessible and actuatable position. Accordingly, the police officer must use both hands, one to hold the flashlight and the other hold the pepper spray canister, while assessing a potentially combative situation. Because such a defensive position requires the use of both hands, the police officer is limited in his ability to perform other actions. Additionally, conventional flashlights and pepper spray containers are often not easily accessible/retrievable from a stored position, thus increasing the time it takes for a person to equip the flashlight and/or pepper spray canister in hand.

### SUMMARY

From the foregoing discussion, it should be apparent that a need exists for an apparatus, system, and method for a flashlight with an integrated pepper spray apparatus that overcome the limitations of conventional defensive equipment. Beneficially, such an apparatus, system, and method would provide an effective system for conveniently using flashlight with an integrated pepper spray dispenser.

The subject matter of the present application has been developed in response to the present state of the art, and in particular, in response to the problems and needs in the art that have not yet been fully solved by currently available defensive equipment. Accordingly, the present disclosure has been developed to provide flashlight and integrated pepper spray apparatus and system that overcome many or all of the above-discussed shortcomings in the art.

According to one embodiment, a flashlight apparatus includes a light emitting module at a distal end, a pepper spray module at a proximal end, and a plurality of interchangeable modules positioned between the light emitting module and the pepper spray module. The pepper spray module includes an actuator, a nozzle, and a pepper spray compartment capable of housing a pepper spray source. The actuator includes a pepper spray switch and a pepper spray channel. The pepper spray channel is fluidly connectable with the pepper spray source when housed by the pepper spray compartment and is fluidly connected to the nozzle. Actuation of the pepper spray switch releases pepper spray fluid from the pepper spray source, through the pepper spray channel, and through the nozzle. The interchangeable modules include a power supply module that includes a power compartment capable of housing a power source. Further, the interchangeable modules include a power switch module for selectively supplying power from the power source to the light emitting module when the power source is housed by the power compartment.

In some implementations of the flashlight apparatus, the nozzle is configured to eject the pepper spray fluid in a direction substantially perpendicular to a longitudinal axis of the flashlight apparatus. The pepper spray module can include a locking ring that is releasable to allow rotation of the actuator and nozzle relative to the power switch module and tightenable to prevent rotation of the actuator and the nozzle relative to the power switch module. The pepper spray compartment may be rotationally fixed relative to the power switch module while the actuator and nozzle are rotatable relative to the power switch module.

According to some implementations of the flashlight apparatus, the pepper spray switch is movable in a radially outward direction perpendicular to a central axis of the flashlight apparatus, and a distal direction toward the distal end, to actuate the pepper spray switch. The actuator can prevent movement of the pepper spray switch in the distal direction until the pepper spray switch has been first moved in the radially outward direction.

In yet some implementations of the flashlight apparatus, the interchangeable modules further include a mounting module that has an engagement element configured to releasably engage a holster. The mounting module includes a locking ring that is releasable to allow rotation of the engagement element relative to the power switch module and tightenable to prevent rotation of the engagement element relative to the power switch module.

According to certain implementations of the flashlight apparatus, the interchangeable modules include at least one spacer module.

In yet another embodiment, a system includes a holster and an apparatus. The holster includes a holster base that is coupleable to a user, and a holster body that is affixed to the holster base. The holster body includes a quick-coupler element. The apparatus includes a light emitting module at a distal end and a plurality of interchangeable modules detachably coupled to the light emitting module. The plurality of interchangeable modules includes a mounting module having an engagement element that detachably engages the quick-coupler element of the holster body.

According to some implementations of the system, the holster base includes apertures for engaging a belt of the user. In certain implementations, the holster body is detachably affixed to the holster base to allow the user to adjust an angular orientation of the holster body relative to the holster base. In yet certain implementations, the holster body is rotatably affixed to the holster base via a rotatable attachment mechanism to allow the user to adjust an angular orientation of the holster body relative to the holster base. In some implementations, the holster body is slidably affixed to the holster base via a sliding attachment mechanism.

In some implementations of the system, the mounting element includes one of a recess and a spring-loaded protrusion. The spring-loaded protrusion has a peripheral shape that conforms to an internal shape of the recess. The quick-coupler element includes the other of the recess and the spring-loaded protrusion.

According to certain implementations of the system, one or the other of the holster body and mounting module includes a tapered lead-in section to guide the engagement between the engagement element and the quick-coupler element.

In yet another embodiment, an aerosol apparatus includes an aerosol compartment that is capable of housing an aerosol source that contains an aerosol fluid. The aerosol apparatus also includes a dispensing channel that includes a first end and a second end. The first end is capable of being positioned in fluid receiving communication with the aerosol source. The aerosol apparatus also includes an actuator with a switch and a nozzle. The nozzle is in fluid receiving communication with the second end of the dispensing channel. Actuation of the switch releases aerosol fluid from the aerosol source, through the dispensing channel, and through the nozzle. The switch is movable in a radially outward direction perpendicular to a central axis of the apparatus and a distal direction parallel to the central axis of the apparatus toward the aerosol compartment to actuate the switch. The actuator prevents movement of the switch in the distal direction until the switch has been first moved in the radially outward direction.

According to some implementations of the aerosol apparatus, a bottom portion of the aerosol compartment is coupled to interchangeable modules that form a flashlight apparatus. Light is emitted in the distal direction from a light emitting module positioned at a distal end of the flashlight apparatus. The aerosol fluid can be pepper spray. Furthermore, in certain implementations, movement of the switch in the radially outward direction causes an elongated rear horizontal slot to move about a rear guide pin in the radially outward direction and causes an L-shaped front slot to move about a front guide pin in the radially outward direction. Movement of the switch in the distal direction causes the switch to pivot about the rear guide pin and causes the L-shaped front slot to move about the front guide pin in an arced distal direction.

Reference throughout this specification to features, advantages, or similar language does not imply that all of the features and advantages that may be realized with the present disclosure should be or are in any single embodiment of the invention. Rather, language referring to the features and advantages is understood to mean that a specific feature, advantage, or characteristic described in connection with an embodiment is included in at least one embodiment of the subject matter disclosed herein. Thus, discussion of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize that the subject matter of the present application may be practiced without one or more of the specific features or advantages of a particular embodiment. In other instances, additional features and advantages may be recognized in certain embodiments that may not be present in all embodiments of the disclosure. Further, in some instances, well-known structures, materials, or operations are not shown or described in detail to avoid obscuring aspects of the subject matter of the present disclosure. These features and advantages of the present disclosure will become more fully apparent from the following description and appended claims, or may be learned by the practice of the disclosure as set forth hereinafter.

### BRIEF DESCRIPTION OF THE DRAWINGS

In order that the advantages of the disclosure will be readily understood, a more particular description of the disclosure briefly described above will be rendered by reference to specific embodiments that are illustrated in the appended drawings. Understanding that these drawings depict only typical embodiments of the disclosure and are not therefore to be considered to be limiting of its scope, the subject matter of the present application will be described and explained with additional specificity and detail through the use of the accompanying drawings, in which:

FIG. 1A is a side view of one embodiment of a flashlight and integrated pepper spray apparatus;

FIG. 1B is a side view of one embodiment of a flashlight and integrated pepper spray apparatus in the hand of a user;

FIG. 2 is a perspective view of one embodiment of a system that includes a flashlight and integrated pepper spray apparatus and a holster attached to apparel of a user;

FIG. 3A is a perspective view of one embodiment of a holster;

FIG. 3B is a perspective exploded view of one embodiment of a holster that includes a holster base and a holster body and a rotatable attachment mechanism;

FIG. 4 is a cross-sectional view of one embodiment of an aerosol dispensing apparatus;

FIG. 5A is a cross-sectional view of one embodiment of an aerosol dispensing apparatus in a safety position;

FIG. 5B is a cross-sectional view of one embodiment of an aerosol dispensing apparatus in a ready position;

FIG. 5C is a cross-sectional view of one embodiment of an aerosol dispensing apparatus in a dispensing position; and

FIG. 6 is a schematic flow chart diagram of one embodiment of a method for dispensing an aerosol fluid.

### DETAILED DESCRIPTION

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present disclosure, however, absent an express correlation to indicate otherwise, an implementation may be associated with one or more embodiments.

Furthermore, the described features, structures, or characteristics of the disclosure may be combined in any suitable manner in one or more embodiments. In the following description, numerous specific details are provided. One skilled in the relevant art will recognize, however, that the subject matter of the present application may be practiced without one or more of the specific details, or with other methods, components, materials, and so forth. In other instances, well-known structures, materials, or operations are not shown or described in detail to avoid obscuring aspects of the disclosure.

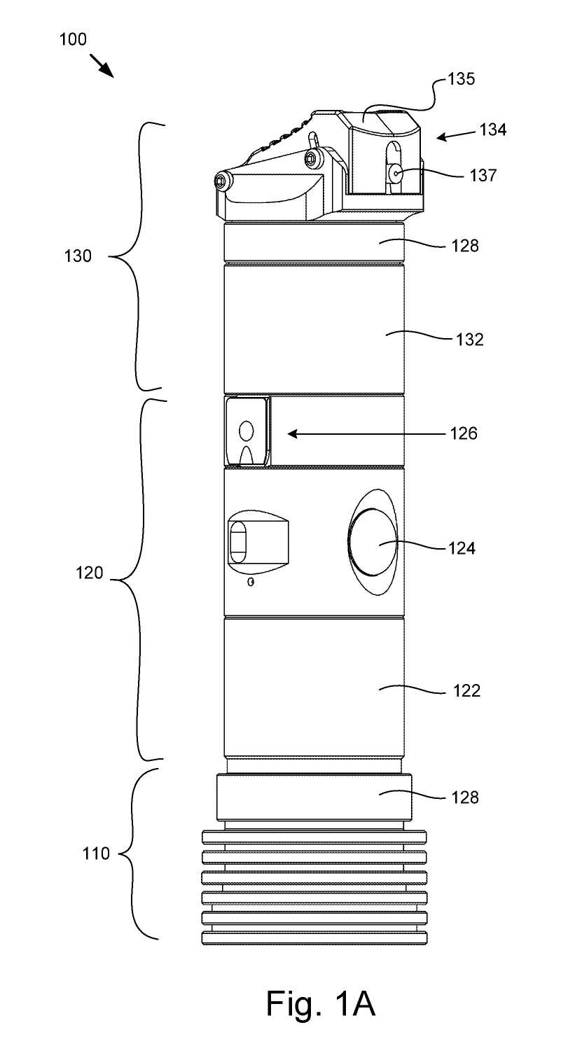

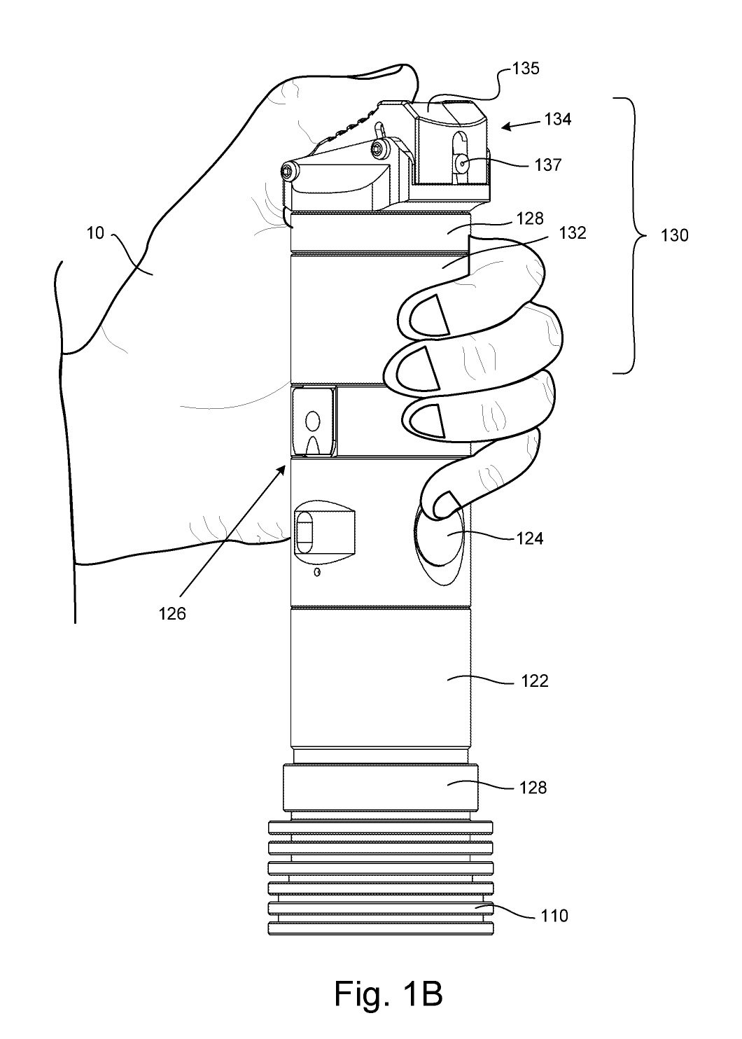

FIG. 1A is a side view of one embodiment of a flashlight and integrated pepper spray apparatus 100. The apparatus 100 has a light emitting module 110 at a distal end, a plurality of interchangeable modules forming the body 120 of the apparatus, and pepper spray module 130 at a proximal end. The light emitting module 110 may include an incandescent bulb assembly or a light emitting diode (“LED”) assembly. Examples of the interchangeable modules forming the body 120 include a power supply module 122, a power switch module 124, a mounting module 126, and a spacer module. In between, coupled to, or forming part of the interchangeable modules of the body 120 may be locking rings 128 among other components. The pepper spray module 130 at the proximal end has a pepper spray compartment and other components for dispensing a pepper spray fluid. Additional details relating to the apparatus 100 and its modules are included immediately below, with additional details pertaining to the use of the apparatus included below with reference to FIG. 1B.

The terms “distal” and “proximal” are used in reference to a situation where a user has the apparatus 100 in hand and is shining the flashlight in a direction away from the user. In such a situation, the portion of the apparatus 100 nearest the user is the proximal end 130 and the portion of the apparatus 100 away from the user is the distal end 110 (with the plurality of interchangeable modules of the body 120 in-between the two ends 110, 130), as depicted in FIG. 1B and as described below with reference to FIG. 1B. In other situations and circumstances, such as when the apparatus is mounted to a user's apparel (as discussed below) or when the apparatus is in a pepper spray dispensing position, the distal end 110 may actually be nearer to the user and the proximal end 130 may be farther away from the user. In other words, the terms “distal” and “proximal” do not limit the disclosure to implementations where the distal end 110 is directed away from the user or from a reference object and where the proximal end 130 is directed towards the user or towards a reference object.

As mentioned above, the body of the apparatus 100 is made from interconnectable and interchangeable modules of the body 120. The interconnected ordering, the rotation orientation, and the longitudinal spacing of the interchangeable modules of the body 120 may be selected according to the preferences of a user (as described in greater detail below with reference to FIG. 1B). In other words, the interchangeable modules of the body 120 are detachably coupled together, via threaded connections or other coupling means, to allow a user to position the interchangeable modules according to his/her preferred grip on the apparatus. The plurality of interchangeable modules of the body 120 at least includes a power supply module 122 and a pepper spray module 124, according to one embodiment. Such an embodiment also utilizes locking rings 128, as described below.

The power supply module 122 includes a power supply compartment 123 that houses a power source, such as a battery pack. The power source (i.e., battery pack) may be permanently mounted to or integrated with the power supply compartment 123. In such embodiments, the power source may be rechargeable and the supply compartment 123 may have an electrical interface (port) for charging the batteries. In another embodiment, the power source may be removable and replaceable (i.e., disposable batteries). The power supply compartment 123 includes electrical leads that contact the terminals of the power source and that electrically connect to the power switch module 124 and the light emitting module 110 at the distal end of the apparatus 100. As described above, the light emitting module 110 includes a lamp (e.g., incandescent bulb, LEDs) and may include a parabolic reflector assembly, power circuitry, a protective lens, and other relevant light assemblies.

In one embodiment, the power switch module 124 includes an on/off type switch. For example, the power switch may be a depressible button or a two-position sliding switch that toggles the light emitting module 110 between on state and an off state. In another embodiment, the power switch 124 is a variable position switch that allows a user to select a desired light intensity, color, pulse, or hue. For example, the power switch 124 may be a sliding switch that allows a user to select how many of the LED units in the light emitting module 110 to illuminate. In another implementation, the power switch 124 may be a depressible button that toggles through various states, such as ‘off’, ‘on-pulse’, and ‘on-continuous’ (among others).

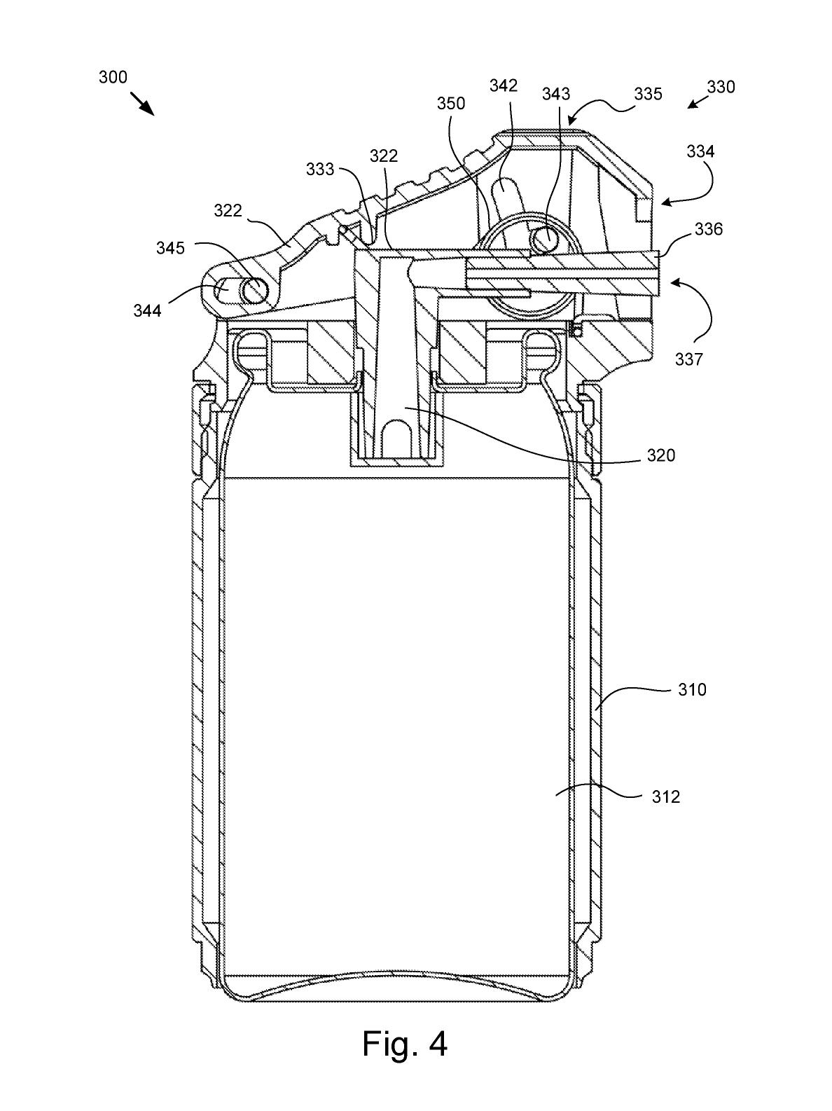

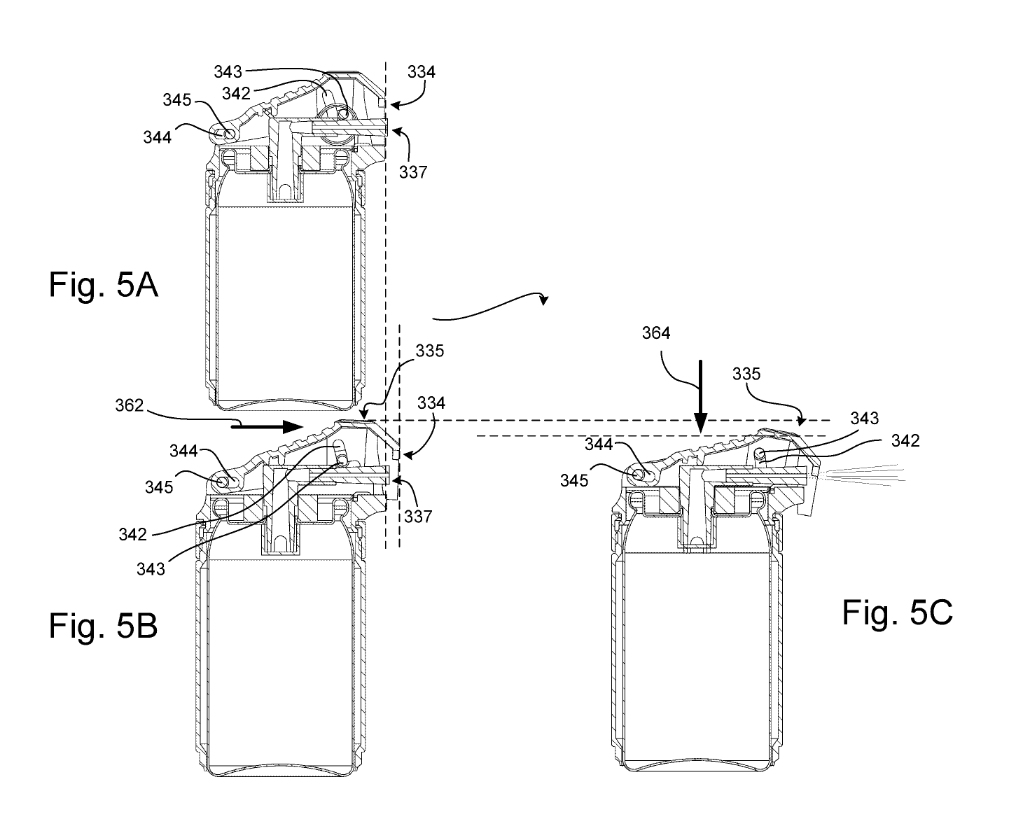

The pepper spray module 130 includes a pepper spray compartment 132 that houses a pepper spray source. The pepper spray source contains a pepper spray fluid. Pepper spray fluid, as defined in the present disclosure, is a lachrymatory agent or other compound that temporarily debilitates an assailant. The pepper spray fluid may be an oleoresin capsicum (“OC”) spray, an OC gas, a tear gas, or other fluid/dispersant capable of incapacitating a person. The pepper spray supply compartment 132 may be specifically sized and configured to receive and engage a specific type of pepper spray canister. In one embodiment, pepper spray supply compartment 132 may be switched out and replaced with a different pepper spray supply compartment 132 based on the type, length, volume, or fluid properties of the specific pepper spray canister implemented in a given application. The pepper spray module 130 further includes an actuator 134 that includes a pepper spray switch 135 and an internal pepper spray channel 136 (not depicted in FIG. 1A). The pepper spray channel 136 has a first end and a second end. The first end can be connected in fluid receiving communication with the pepper spray source and the second end is fluidly connected to a nozzle 137. Additional details regarding the pepper spray module 130 are included below with reference to FIGS. 4-5C.

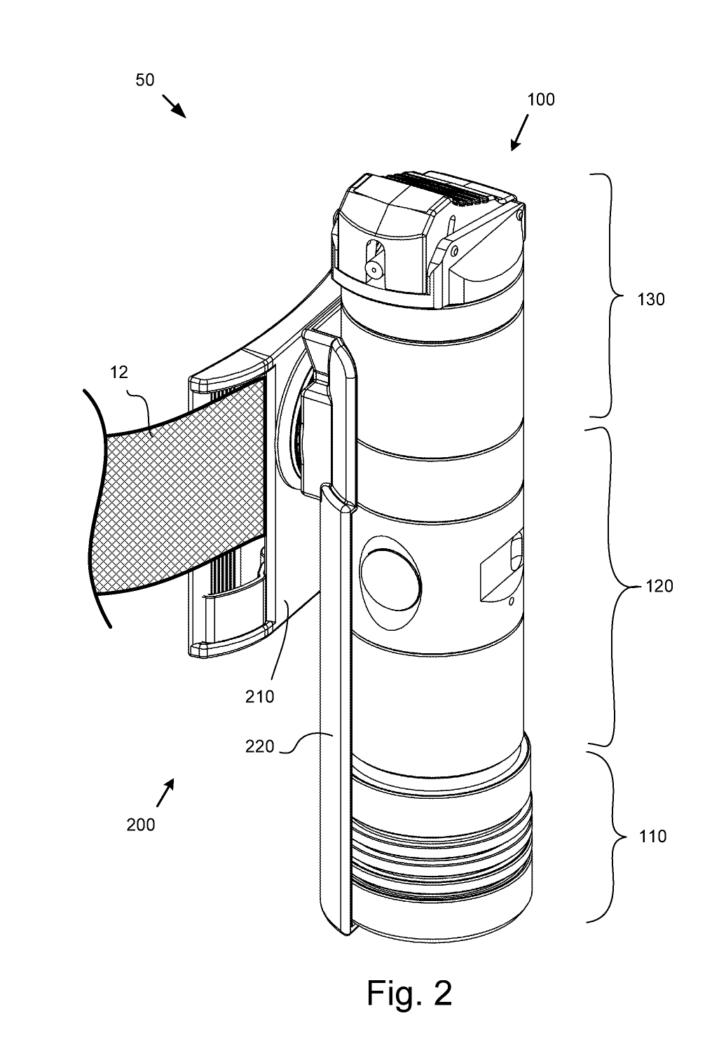

As mentioned above, the body of the apparatus 100 may include locking rings 128 that allow a user to couple the various interchangeable modules of the body 120 together while still allowing the individual interchangeable modules of the body 120 to be independently rotated about the central axis of the apparatus (more details below). The interchangeable modules of the body 120 may, according to one embodiment, further include a mounting module 126 and longitudinal spacers (not depicted). Additional details relating to the mounting module 126 are included below with reference to FIG. 2 and the longitudinal spacers are described below with reference to FIG. 1B.

The various interchangeable modules of the body 120, as well as the distal and proximal ends 110, 130 of the apparatus 100, may be constructed of (or housed within) a strong material that is capable of handling repeated use in defensive and/or combat situations. As briefly described above, the apparatus 100 may be used by police officers, military personnel, security guards, or other private/individual users in preparation or anticipation of a physical struggle. Therefore, the various components, elements, and portions of the apparatus 100 need to be constructed from a material that is capable of withstanding defensive combat situations. For example, the apparatus 100 may be constructed from a metallic or dense polymeric material that is strong enough to withstand repeated use in combat related situations. Additionally, although depicted throughout the figures as a substantially cylindrical apparatus 100, it is anticipated that the cross-sectional shape of the apparatus may have other shapes, such as rectangular, elliptical, or polygonal.

FIG. 1B is a side view of one embodiment of the flashlight and integrated pepper spray apparatus 100 in the hand 10 of a user. As depicted, the hand 10 of the user is supporting the apparatus 100 so that a longitudinal axis of the apparatus extends in a substantially vertical direction with the light emitting module 110 facing down while the pepper spray dispensing nozzle 137 of the pepper spray module 130 is directed in a substantially horizontal direction. In such an implementation, the user is ready to actuate the pepper spray module 130 and dispense pepper spray fluid in the substantially horizontal direction (the pepper spray actuator 132 is described in greater detail below). Throughout the pages of the disclosure, this position is referred to as the “pepper spray position” or the “dispensing position”. Although not depicted, the user may move his arm and hand 10 to reorient the apparatus 100 so that the longitudinal axis of the apparatus 100 extends in a substantially horizontal direction with the pepper spray dispensing nozzle 137 pointed up while the light emitting module 110 is directed in the substantially horizontal direction. Throughout the pages of the disclosure, this position is referred to as the “flashlight position”. As depicted, the orientation of the user's grip allows him/her to depress or otherwise activate the power switch 124 and thereby control the light emitting module 110.

Although the depicted embodiments of the apparatus 100 show the pepper spray dispensing nozzle 137 disposed on the pepper spray module 130 and facing a direction substantially perpendicular to the longitudinal axis of the apparatus 100, it is anticipated that the nozzle 137 may be located at another position along the length of the apparatus and/or may face a different direction. For example, in one embodiment the pepper spray dispensing nozzle 137 may be integrated with one of the described interchangeable modules of the body 120 or may comprise a separate, independent interchangeable module of the body 120. In other words, for example, the pepper spray dispensing nozzle 137 may be integrated with the light emitting module 110 at the distal end of the apparatus 100, thus allowing a user to dispense pepper spray fluid in substantially the same direction as the light emanating from the light emitting module 112. In such an embodiment, a pepper spray dispensing channel extends through the interchangeable modules of the body 120 in order to deliver the pepper spray fluid to the pepper spray dispensing nozzle 137.

Because the body of the apparatus 100 is formed from interchangeable modules of the body 120, the interconnected ordering, the rotational orientation, and the longitudinal spacing of the interchangeable modules may vary according to the preferences of a user or according to the specifications of a certain implementation. In other words, the order in which the modules of the body 120 are coupled together, the relative rotational orientation of the various modules of the body 120, and the longitudinal (axial) spacing between various modules of the body 120 are customizable. For example, the order, orientation, and general positioning of the interchangeable modules of the body 120 may be based on whether the user is right or left handed. In another embodiment, for example, the order, orientation, and general positioning of the interchangeable modules of the body 120 may be determined, or at least limited, by the operating parameters of a specific implementation, such as the relative size of the pepper spray canister or the relative length of the battery pack in reference to, for example, the length of a holster (see below).

In one embodiment, the pepper spray actuator 134 is coupled to the pepper spray supply compartment 132 using a locking ring 128 that allows the pepper spray actuator 134 to rotate around the central axis of the assembled apparatus in order to be rotationally positioned. For example, the actuator 134 may be rotated so that it can be actuated by the thumb of an individual while still allowing a finger tip from the same hand 10 to be aligned with the power switch 124 for actuating the lighting functions of the apparatus 100.

Locking rings 128, as described briefly above, are sleeves that are rotatably affixed to an interchangeable module and that have threads that engage with corresponding threads on different interchangeable module. For example, the top locking ring 128 may actually be a sleeve that is permanently but rotatably affixed to the actuator 134, thus allowing the rotational orientation of the actuator 134, with respect to another interchangeable module (such as the power switch 124), to be maintained by tightly engaging the internal threads of the locking ring 128 onto corresponding threads on the next-in line interchangeable module of the body 120 (i.e., the pepper spray supply compartment in FIG. 1B). In such an embodiment, the hand 10 of the user has instant and convenient access to both the lighting function and defensive pepper spray function of the apparatus 100 without needing to reorient the apparatus within the user's hand 10 or without the needing to obtain a new grip/grasp on the apparatus 100. The top locking ring 128, therefore, allows each user to adjust the relative rotational orientation of the pepper spray actuator 134 and the power switch 124. Accordingly, it is anticipated that the locking rings 128 may be included as independent modules that facilitate coupling two other modules together or the locking rings 128 may be integrated with an existing module, such as the top locking ring 128 in FIG. 1B that is part of the pepper spray module 130.

In another embodiment, the mounting module 126, whether implemented as an independent interchangeable module of the body 120 or whether attached to a locking ring that is rotatably affixed to an interchangeable module of the body 120, includes an engagement element 127 that engages a corresponding quick-coupler element on a holster (described below in greater detail). Thus, the mounting module 126 may be rotationally oriented, with respect to the power switch module 124 and the pepper spray module 130, so that it can conveniently engage the mating quick-coupler of a holster. Therefore, the relative rotational orientations of the mounting module 126, the power switch 124, and the pepper spray actuator 134 may be customized to allow a user to grasp and retrieve the apparatus 100 from a holster and raise the apparatus to a useful, actuatable position (lighting position or dispensing position) without needing to re-grasp or re-orient his/her hand on the apparatus 100. In other words, a user can instantly access the apparatus 100 from its stored position in a mating holster by grasping the apparatus with the hand 10 in the same position as when the apparatus is actuated, whether as a flashlight or a pepper spray dispenser (e.g., the thumb is correctly positioned to actuate the pepper spray actuator 134 while a finger tip from the same hand 10 is available to actuate the switch 124 to select a desired lighting function).

In yet another embodiment, the mounting module 126 may be used to mount secondary attachments to the apparatus 100 or to mount the apparatus 100 to structures other than the holster. For example, the mounting module 126 (or a separate interchangeable module added to the body 120 of the apparatus 100) may be configured to engage corresponding mounting features on a rifle, tripod, vehicle panel, or other structure, thus allowing a user to quickly mount the apparatus 100 in a certain position and subsequently retrieve the apparatus 100 in rapid fashion.

In another embodiment, depending on the size of the user's hand 10, the longitudinal spacing of the various interchangeable modules of the body 120 may need to be adjusted. Therefore, longitudinal spacers or spacer modules (not depicted) may be incorporated between certain interchangeable modules of the body 120. For example, longitudinal spacers may be used to adjust the distance between the pepper spray actuator 134 and the power switch 124. In another embodiment, instead of using independent longitudinal spacers, the individual interchangeable modules of the body 120 themselves may be switched out with other modules that have different lengths.

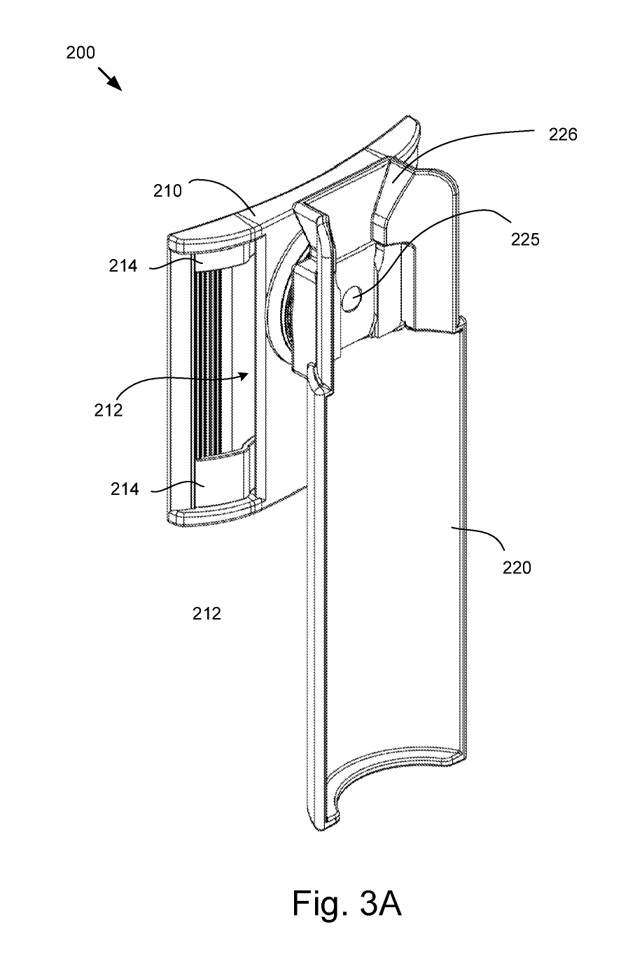

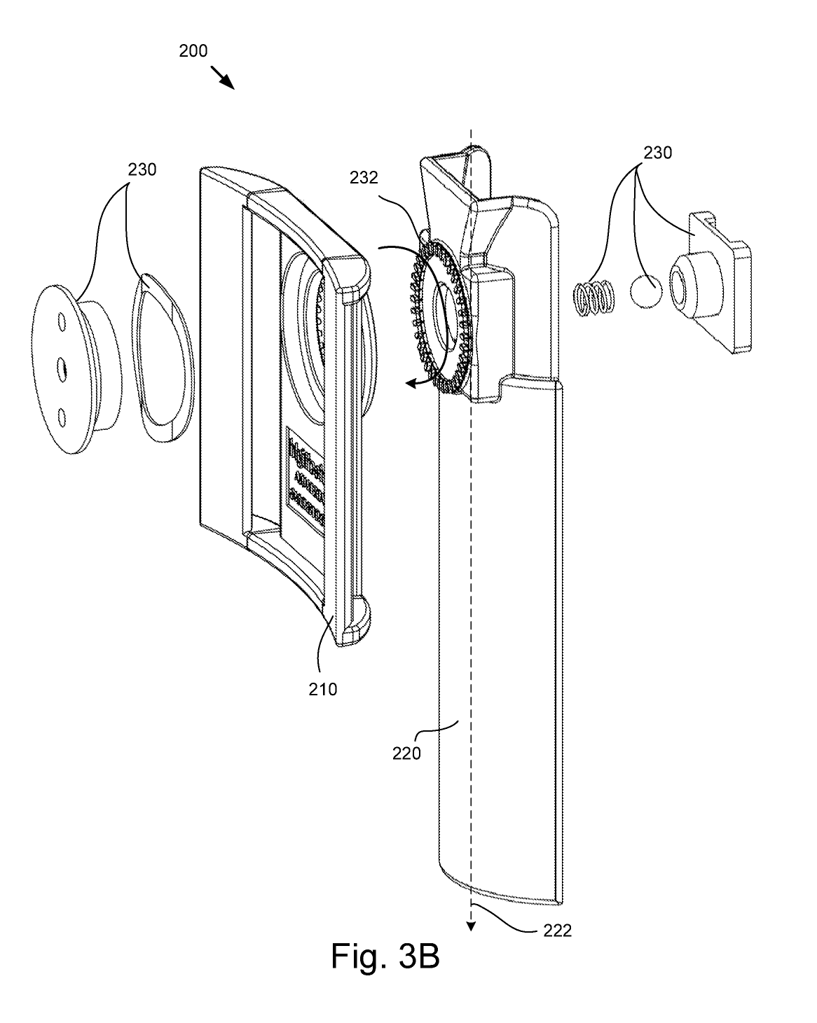

FIG. 2 is a perspective view of one embodiment of a system 50 that includes a flashlight and integrated pepper spray apparatus 100 and a holster 200 attached to apparel 12 of a user. As described above, the apparatus 100 may be used by police officers or other individuals to provide efficient and easy access to the lighting function and/or the pepper spray function. Accordingly, the system 50 depicted in FIG. 2 includes a holster 200 that can be easily and adaptably attached to a user's apparel 12. For example, the depicted holster 200 includes a holster base 210 coupled to a holster body 220. Additional details relating to the holster 200 are included below with reference to FIGS. 3A and 3B. The holster base 210 may include apertures (described in greater detail below with reference to FIG. 3A) through which a belt or a strap of a user's apparel may extend. In other embodiments, although not depicted, the apparel 12 to which the holster 200 is attached may include a vest, a shirt, pants, a backpack, or other user accessory and the holster base 210 may include a clip, fastener, a strap, a band, a tie, a clasp, or other attachment means for securely attaching to a user's apparel 12.

FIG. 3A is a perspective view of one embodiment of a holster 200. The holster 200 includes a holster base 210 and a holster body 220. The apertures 212 in the holster base 210 may include an adjustable, tension-mounted spacer 214 that allows belts or straps of various widths to be securely engaged with the holster base 210. The adjustable spacers 214 may also be used to modify the height, in relation to the belt 12, of the holster base 210, thus allowing a user to further customize the position of the holster body 220. Further, the adjustable spacers 214 may be angled within the apertures 212, thus imparting an initial tilt to the holster base 210.

The holster body 220 is designed to have a shape that conforms to the outside peripheral surface of the apparatus 100. In one embodiment, the holster body 220 contours and conforms to less than 180 degrees around the peripheral surface of the apparatus 100. In such an embodiment, the user may still obtain an adequate grasp on apparatus 100 by wrapping his/her hand greater than 180 degrees around the apparatus 100. The length of the holster body 220 may extend beyond the edge of the apparatus 100 (when mounted) to protect the apparatus 100 from being accidentally knocked out of the holster 200. In another embodiment, the apparatus 100 and the holster body 200 may be configured to have substantially the same length. In such an embodiment, the lower edge of the holster body 220 may then have a lip that provides additional support to the apparatus 100 when mounted to the holster 200.

The holster body 220 includes a quick-coupler element 225 that engages the engagement element 127 of the mounting module 126 of the apparatus 100. The quick-coupler element 225, for example and according to one embodiment, may include a spring loaded protrusion that engages a recess of the engagement element 127. As shown in FIGS. 1A and 1B, the engagement element 127 may have a spherical recess into which the spring-loaded protrusion partially extends to form a seated engagement that holds the apparatus 100 in a detachably secure engagement with the holster 200. The orientation of the holster body 220, as described below with reference to FIG. 3B, may be configured so that the apparatus 100 can be removed/retrieved in a single, fluid motion in order to be quickly actuated used as a defensive tool.

The holster body 220 may further include a tapered lead-in segment 226 to facilitate easy re-holstering of the apparatus 100. The apparatus 100 can be easily visually aligned above its mounted position in the holster 200 with the distal end 130 being aligned by its corresponding matching peripheral surface to the holster body 200. The user may then move the apparatus 100 in a typically downward motion. Although described as a spring-loaded protrusion mechanism, the holster 200 may be implemented with other quick-coupler assemblies that allow a user to rapidly retrieve the apparatus 100 from its mounted position within the holster 200.

FIG. 3B is a perspective exploded view of one embodiment of a holster 200 that includes a holster base 210, a holster body 220, and a rotatable attachment mechanism 230. The rotatable attachment mechanism 230 allows a user to tilt the holster body 220. In other words, the extension direction 222 of the holster body 220 in relationship to the base 210 may be customized according to a user's preference. This allows the holster body 220 to be oriented so that the apparatus 100, when housed in the holster body 220, is angled so that a user's hand can quickly and ergonomically grasp the apparatus 100 with a natural/preferred alignment of the hand and arm. The ability to tilt the extension direction 222 of the holster body 220 to a desired angle allows for the apparatus 100 to be retrieved in a number of different orientations.

For example, most police officers hold their flashlights so that the head of the light is closest to their “pinkie” finger (see FIG. 1B), thus allowing them to shine the light from a higher position. In another embodiment, however, a different extension direction of the holster body 220 may be selected to position the apparatus 100 so that it can be more conveniently removed in an orientation where the light emitting module 110 is closest to a user's thumb, thus allowing the light to be used from a comparatively lower position. Further, the rotational flexibility of the holster body 220 facilitates the holster base 210 being able to be attached to locations other than the waste/belt region (if desired).

The rotatable attachment mechanism 230 may include a spring tensioned joint. The spring tensioned joint, according to the depicted embodiment, may include a spring wave and a compression spring on opposite sides of the joint. By providing a counter force to the springs, the rotational engagement of the holster base 210 to the holster body 220 can be changed without the use of tools, allowing quick adjustment to the desired extension direction 222. The depicted design allows the holster body 220 to be pulled away from the holster base 210, compressing a wave type spring and allowing the locking teeth 232 to disengage so that a user can rotate the body 220 to assume a new extension direction 222. Releasing the tension allows the locking teeth 232 to engage at the selected rotational position, once again preventing movement between the holster body 220 and the holster base 210.

In another embodiment (not depicted), the holster 200 may further include a slidable attachment mechanism. The slidable attachment mechanism may include a channel extending the length of the holster body 220, thus allowing the holster base 210 to be coupled to the channel and slidably moved along the channel to affix holster body 220 at various positions along the length of the holster body 220. The slidable attachment mechanism further facilitates flexibility and convenience in mounting an apparatus within the holster 200.

FIG. 4 is a cross-sectional view of one embodiment of an aerosol dispensing apparatus 300. The description and implementation details regarding the aerosol dispensing apparatus 300 that are included below may be applied to the pepper spray module 130 (pepper spray compartment 132, actuator 134, nozzle 137, etc). Alternatively, the aerosol apparatus 300 may also be implemented as a stand-alone dispenser mechanism that can be used with various aerosols and for various purposes. For example, the aerosol apparatus 300 may be implemented in conjunction with a fragrant aerosol application, a cleaning aerosol application, and a painting aerosol application, among others.

The aerosol apparatus 300, according to one embodiment, includes an aerosol compartment 310 that can house an aerosol canister 312. The compartment 310 may completely enclose the canister 312, as depicted, or the compartment 310 may simply temporarily attach to a portion of the canister 312 (i.e., the top portion). The apparatus 300 further includes a dispensing channel 320 through which the aerosol fluid flows. The dispensing channel 320 fluidly connects to the nozzle 336 where the aerosol fluid may be dispensed into the atmosphere. The aerosol apparatus 300 further includes an actuator 330 that includes a switch 332 and the nozzle 336. The switch 332 has an actuation surface 333 that, when the switch is depressed, engages a channel surface 322, thus actuating the release of aerosol fluid into the dispensing channel 320.

The aerosol apparatus 300, according to one embodiment, further includes a front guide pin 343 extending through an L-shaped front slot 342 and a rear guide pin 345 extending through a horizontal rear slot 344. The aerosol apparatus 300 further includes a spring 350 that holds the switch 332 in the depicted “at rest” or “safety” position. Details regarding the actuation of the switch 332 and the function of the guide pins 343, 345 and the slots 342, 344 are included below with reference to FIGS. 5A-5C. FIG. 4 also shows a front surface of the switch 334, a top surface of the switch 335, and a front surface of the nozzle 337. These surfaces are described below with reference to actuating the aerosol apparatus 300.

FIG. 5A is a cross-sectional view of one embodiment of an aerosol dispensing apparatus 300 in a safety position. As briefly described above, the aerosol apparatus 300 may have an actuator 330 that requires a user to first move the actuator switch 332 in a first direction before being able to move the switch 332 in a second direction. Such a configuration prevents accidental discharge of the aerosol fluid. For example, if the flashlight and integrated pepper spray apparatus 100 described above implemented a pepper spray actuator 134 comparable to the aerosol actuator 330 shown in and described with reference to FIGS. 4-5C, the pepper spray actuator 134 would prevent a police officer or other user from accidentally dispensing pepper spray fluid. Such an actuator is important in certain implementations, such as the system 50 described above, where the apparatus 100 is coupled to a holster 200 on a user's belt. The elbow or arm of user may frequently make contact with the pepper spray actuator 134, thus potentially causing inadvertent discharge of pepper spray fluid were it not for an actuator configuration as described herein.

Therefore, according to the depicted embodiment, the aerosol actuator 330 may be in a safety position when the front surface 334 of the switch is substantially aligned with the front surface of the nozzle 337. In other words, the spring 350 may hold the switch 332 in the safety position so that the front guide pin 343 is not in the vertical portion of the L-shaped slot 342, thus preventing the switch from moving in a downward direction 364 and preventing release of aerosol fluid. In the safety position, the rear guide pin 345 is positioned in the front portion of the horizontal rear slot 344.

FIG. 5B is a cross-sectional view of one embodiment of an aerosol dispensing apparatus 300 in a ready position. A user may apply a force to the switch 332 to move the switch 332 in a radially outward direction 362, thus causing the front surface 334 of the switch to extend beyond the front surface 337 of the nozzle. Such a force also causes the front guide pin 343 be positioned at the bottom portion of the vertical segment of the L-shaped front slot 342 and the rear guide pin 345 to be positioned in the rear portion of the horizontal rear slot 344. In the ready position, the switch has not yet actuated an aerosol dispensation but the switch is in position to actuate such a dispensation with a single, downward force on the top surface 335 of the switch.

FIG. 5C is a cross-sectional view of one embodiment of an aerosol dispensing apparatus 300 in a dispensing position. Once in the ready position, a user may then exert a force in the downward direction 364, thus causing the switch to move in a downward direction as the vertical portion of the L-shaped front slot 342 descends downward around the front guide pin 343. While this downward motion may actually be slightly arced due to the pivoting motion created by the rear guide pin 345, the downward movement of the switch causes the actuation surface 333 of the switch 332 to contact the channel surface 322 of the dispensing channel 320, thus actuating a release of aerosol fluid.

In the depicted embodiments, the front surface of the switch 334 initially extends beyond the front surface/edge 337 of the nozzle in the ready position. Upon moving the switch into the dispensing position, the front surface 334 of the switch descends down upon the front surface 337 of the nozzle 336. Therefore, a slit may be disposed in the front surface of the switch 334, thus allowing the nozzle to eject aerosol fluid through the slit. In such an embodiment, the downward movement of the front surface 334 of the switch helps to prevent accidental nozzle blockage by a user's fingers. For example, if a user was holding a conventional aerosol dispenser, upon actuating the dispenser the user might have one or more of his fingers blocking the nozzle 336, thus preventing an aerosol dispensation. However, the configuration of the aerosol actuator 330 of the present disclosure prevents such a problem by causing the front surface 334 of the switch 332 to descend down upon the front surface 337 of the nozzle 336, thus pushing any fingers out of the ejection pathway.

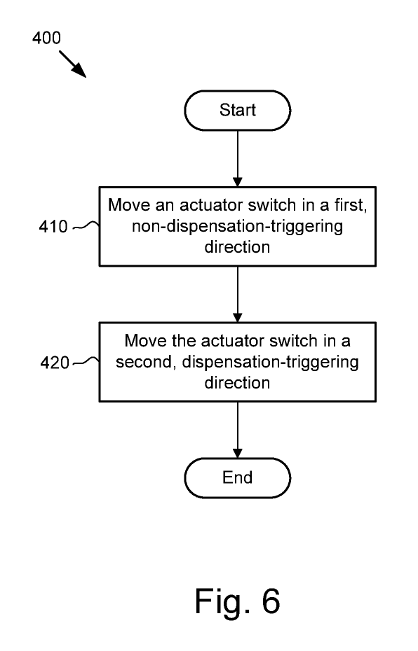

While the embodiments depicted in FIGS. 4-5C show a specific example of an aerosol actuator 330, it is contemplated that other configurations and other structures may be implemented to prevent the inadvertent discharge of aerosol by requiring an actuator to first move from a safety position to a ready position before allowing an actuation triggering movement to occur. FIG. 6 is a schematic flow chart diagram of one embodiment of a method 400 for dispensing an aerosol fluid. The method 400 includes moving an actuator switch in a first, non-dispensation-triggering direction at 410 before moving the actuator switch in a second, dispensation-triggering direction.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

In the above description, certain terms may be used such as “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise.

An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.”

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

The subject matter of the present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. A flashlight apparatus, comprising:
a light emitting module at a distal end;
a pepper spray module at a proximal end, the pepper spray module comprising an actuator, a nozzle, and a pepper spray compartment capable of housing a pepper spray source, the actuator comprising a pepper spray switch and a pepper spray channel, the pepper spray channel being fluidly connectable with the pepper spray source when housed by the pepper spray compartment and being fluidly connected to the nozzle, wherein actuation of the pepper spray switch releases pepper spray fluid from the pepper spray source, through the pepper spray channel, and through the nozzle; and
a plurality of interchangeable modules positioned between the light emitting module and the pepper spray module, the interchangeable modules comprising:
a power supply module comprising a power compartment, the power compartment capable of housing a power source; and
a power switch module for selectively supplying power from the power source to the light emitting module when the power source is housed by the power compartment.

2. The flashlight apparatus of claim 1, wherein the nozzle is configured to eject the pepper spray fluid in a direction substantially perpendicular to a longitudinal axis of the flashlight apparatus.

3. The flashlight apparatus of claim 2, wherein the pepper spray module comprises a locking ring releasable to allow rotation of the actuator and nozzle relative to the power switch module and tightenable to prevent rotation of the actuator and the nozzle relative to the power switch module.

4. The flashlight apparatus of claim 3, wherein the pepper spray compartment is rotationally fixed relative to the power switch module while the actuator and nozzle are rotatable relative to the power switch module.

5. The flashlight apparatus of claim 1, wherein the pepper spray switch is movable in a radially outward direction perpendicular to a central axis of the flashlight apparatus, and a distal direction toward the distal end to actuate the pepper spray switch.

6. The flashlight apparatus of claim 5, wherein the actuator prevents movement of the pepper spray switch in the distal direction until the pepper spray switch has been first moved in the radially outward direction.

7. The flashlight apparatus of claim 1, wherein the interchangeable modules further comprise a mounting module having an engagement element configured to releasably engage a holster.

8. The flashlight apparatus of claim 7, wherein the mounting module comprises a locking ring releasable to allow rotation of the engagement element relative to the power switch module and tightenable to prevent rotation of the engagement element relative to the power switch module.

9. The apparatus of claim 1, wherein the interchangeable modules comprise at least one spacer module.

10. A system comprising:
a holster comprising:
a holster base coupleable to a user; and
a holster body affixed to the holster base, the holster body comprising a quick-coupler element; and
an apparatus comprising:
a light emitting module at a distal end; and
a plurality of interchangeable modules detachably coupled to the light emitting module, the plurality of interchangeable modules comprising a mounting module having an engagement element that detachably engages the quick-coupler element of the holster body.

11. The system of claim 10, wherein the holster base comprises apertures for engaging a belt of the user.

12. The system of claim 10, wherein the holster body is detachably affixed to the holster base to allow the user to adjust an angular orientation of the holster body relative to the holster base.

13. The system of claim 10, wherein the holster body is rotatably affixed to the holster base via a rotatable attachment mechanism to allow the user to adjust an angular orientation of the holster body relative to the holster base.

14. The system of claim 10, wherein the holster body is slidably affixed to the holster base via a sliding attachment mechanism.

15. The system of claim 10, wherein:
the mounting element comprises one of a recess and a spring-loaded protrusion, the spring-loaded protrusion having a peripheral shape that conforms to an internal shape of the recess; and
the quick-coupler element comprises the other of the recess and the spring-loaded protrusion.

16. The system of claim 10, wherein one or the other of the holster body and mounting module comprises a tapered lead-in section to guide the engagement between the engagement element and the quick-coupler element.

17. An aerosol apparatus, comprising:
an aerosol compartment capable of housing an aerosol source that contains an aerosol fluid;
a dispensing channel comprising a first end and a second end, wherein the first end is capable of being positioned in fluid receiving communication with the aerosol source; and
an actuator comprising a switch and a nozzle, the nozzle in fluid receiving communication with the second end of the dispensing channel, wherein actuation of the switch releases aerosol fluid from the aerosol source, through the dispensing channel, and through the nozzle;
wherein the switch is movable in a radially outward direction perpendicular to a central axis of the apparatus and a distal direction parallel to the central axis of the apparatus toward the aerosol compartment to actuate the switch, wherein the actuator prevents movement of the switch in the distal direction until the switch has been first moved in the radially outward direction.

18. The apparatus of claim 17, wherein a bottom portion of the aerosol compartment is coupled to interchangeable modules that form a flashlight apparatus, wherein light is emitted in the distal direction from a light emitting module positioned at a distal end of the flashlight apparatus.

19. The apparatus of claim 17, wherein the aerosol fluid is pepper spray.

20. The apparatus of claim 17, wherein movement of the switch in the radially outward direction causes an elongated rear horizontal slot to move about a rear guide pin in the radially outward direction and causes an L-shaped front slot to move about a front guide pin in the radially outward direction, wherein movement of the switch in the distal direction causes the switch to pivot about the rear guide pin and causes the L-shaped front slot to move about the front guide pin in an arced distal direction.
